(19) United States
(12) Patent Application Publication
(10) Pub. No.: US 2026/0091421 A1
(43) Pub. Date: Apr. 2, 2026

(54) APPARATUS AND A METHOD FOR CONTINUOUS EXTRUSION OF MATERIALS WITH HIGH VISCOSITY

(71) Applicant: NORSK HYDRO ASA, Oslo (NO)

(72) Inventors: Trond FURU, Sunndalsøra (NO); Kristian Grøtta SKORPEN, Ranheim (NO); Harald VESTØL, Kolbotn (NO)

(73) Assignee: NORSK HYDRO ASA, Oslo (NO)

(21) Appl. No.: 19/113,200

(22) PCT Filed: Sep. 19, 2023
(86) PCT No.: PCT/EP2023/075705

§ 371 Date: Mar. 19, 2025

(30) Foreign Application Priority Data
Sep. 23, 2022 (NO) 20221010

(51) Int. Cl. B21C 23/00

(52) U.S. Cl. CPC B21C 23/005

(57) ABSTRACT

An apparatus and method for continuous extrusion of materials with high viscosity, in particular materials containing metals such as aluminium, magnesium, titanium, zinc, copper, nickel and alloys thereof, the apparatus including an Archimedes screw rotationally provided within a liner of a screw housing provided with an feeding opening for feeding of the materials to be extruded, an extrusion zone and an extrusion die assembly with a die which forms the shape of the desired extruded product. The apparatus also having a preparation/mixing zone, further a feeding zone for material that communicates with the Feeding opening of the housing, a transport and compaction zone for the materials in the screw extruder, and a compacting and pressure generating zone for the materials in connection with said extrusion zone, where the required compaction and extrusion pressure and temperature is obtained.

The present invention relates to an apparatus and a method for continuous extrusion of materials with high viscosity.

The materials can be light metals such as aluminium, titanium, magnesium and alloys or mixtures thereof. Other materials such as Cu, Ni and Zn can be relevant.

Also metals with high viscosity and materials with reinforcing particles or fibres can be actual candidates for this application.

The apparatus comprises an extruder including an Archimedes screw provided in a screw housing with an inlet for the feeding of the material to be extruded, a compacting and/or extrusion chamber and an extrusion die assembly with a die which forms the shape of the desired extruded product.

The extruder is preferably fed with granular metal at T<Ts, where the Ts is the temperature at which the metal will have sticking friction. The granular metal may be heated in the extruder by contact with the screw and container wall, or it may be preheated to the desired temperature, preferably before entering the apparatus. As sticking friction occurs, the metal is further heated by frictional heat and deformation. As the semi compacted metal reaches the pressure generating zone, the metal sticks to an already compacted “wing” of metal and becomes kneaded and fully compacted.

According to one aspect of the invention, the operation of the apparatus can be controlled by a controller that is a computer provided with a software program, or in a similar manner by a PLC. The apparatus is provided with sensors for measuring physical parameters as temperature and/or pressure inside the apparatus and the torque and/or speed of the screw. According to one aspect of the invention, also the axial forces acting on the screw can be measured by sensors. Signals from these sensors are collected by the computer and entered in the software program. In addition, systems for controlling the temperature of the material as it propagates through various zones of the apparatus can be provided where input/output from these systems are communicated to/from the computer.

Extrusion of light metals with high viscosity such as aluminium, magnesium or titanium requires a considerably high pressure to force the material through a die block and the die, typically 100 to 500 MPa. The state of the art as regards aluminium extrusion is presently dominated by ram extrusion. Ram extrusion is a batch process in which a billet is loaded into a container and forced (pressed) through a die by means of a moving piston.

In the state of the art, a continuous screw extrusion process is used in the production of lead and lead alloy profiles which is based on the Robertson Hansson extruder, US3693394. In this process the lead is fed to the extruder in liquid state and solidifies during the extrusion process.

Lead behaves differently from for instance aluminium since it has “sliding” friction, i.e. the friction between the lead and the container material (steel) is proportional to the pressure.

Aluminium and many other metals have, however, sticking friction at extrusion temperatures, i.e. the metal welds to the container and the screw material.

As a result of this behaviour, screw extrusion of aluminium and other sticky metals with high viscosity have been difficult and non-practical due to the enormous forces required to overcome the frictional forces between e.g. aluminium and steel.

US9616633 (Norsk Hydro ASA) relates to a screw extruder for the continuous extrusion of materials with high viscosity, in particular metals such as aluminium and its alloys. The extruder includes an Archimedes screw rotationally provided within a liner of a screw housing. The housing is provided with an inlet for feeding the material to be extruded, a compacting or extrusion chamber and an extrusion die assembly with a die that forms the shape of the desired extruded product. The design of the screw and liner is such that the required compaction takes place at the down-stream end of the screw towards the extrusion chamber corresponding to up to 540° of the rotation of the screw, or up to 1,5 turn of the screw flight length, and that a solid plug of metal is formed at the end of the screw and extrusion chamber and further restricted from rigid rotation to obtain the required compaction and extrusion pressure.

The present invention benefits from some principles as disclosed in US9616633. However, according to the present invention there has been achieved many improvements with regard to the state of the art screw extruding process.

The inventors have done a lot of trials and have proposed improvements related to the state of the art screw extruder and also with regard to the corresponding process parameters and a method for operating an extruder.

According to the present claims, the invention represents an efficient extruder and a method for operating same, enabling making products in an efficient manner and of various starting materials by a steady-state process.

The apparatus according to the invention is characterized by the features as defined in the accompanying independent claim 1.

Preferred embodiments of the apparatus are further defined in the attached dependent claims 2-6.

The method for continuous extrusion of materials with high viscosity is characterized by the features as defined in the accompanying independent claim 7.

Preferred embodiments of the method are further defined in the attached dependent claims 7-12.

The invention will be further described in the following by way of example and with reference to the drawings where:

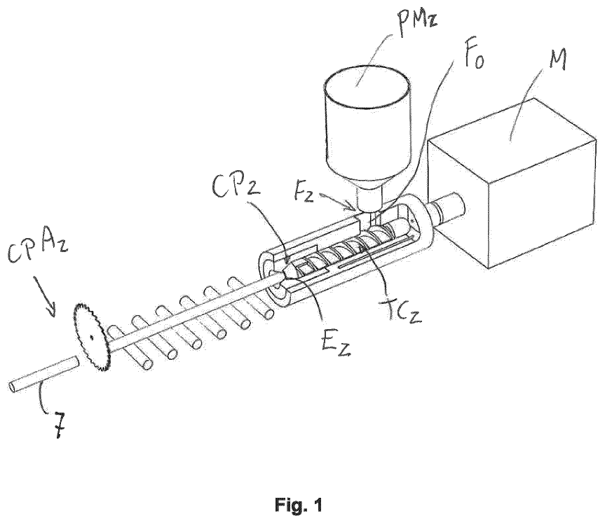

FIG. 1 shows schematically a view of an extruder apparatus according to the present invention, where the extruder is shown in a cut view,

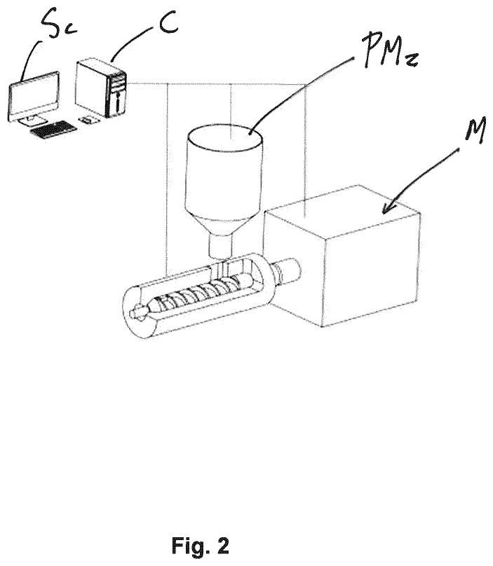

FIG. 2 shows a side view of the extruder apparatus as shown in FIG. 1, controlled by a computer,

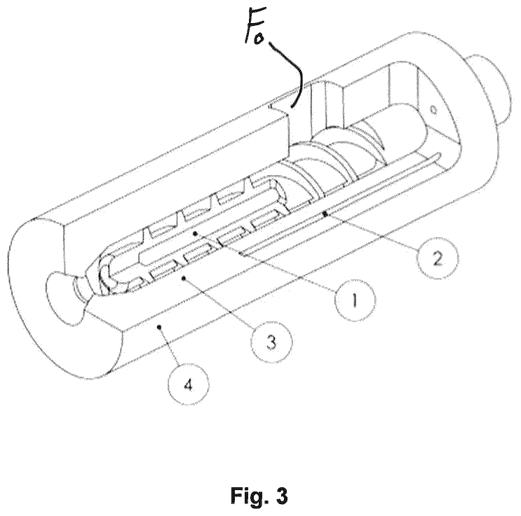

FIG. 3 shows a cut through of a screw housing/container of an extruder apparatus with several cooling/heating zones of a liner part of the extruder,

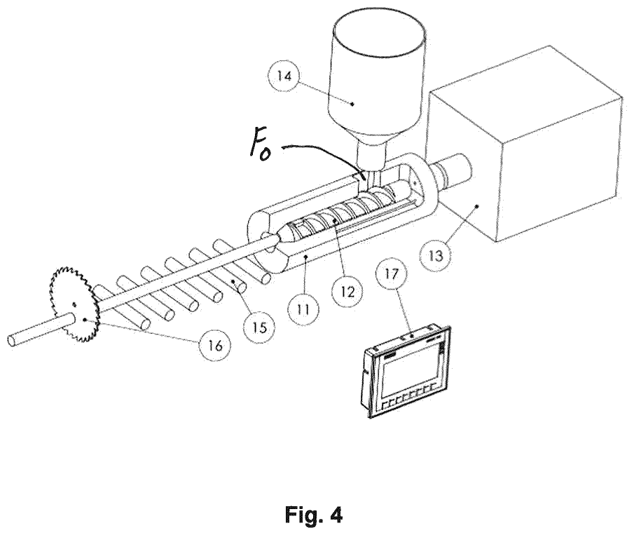

FIG. 4 shows in an embodiment details related to the temperature measurements and control as of FIG. 3,

FIG. 5 discloses details of the processing zones in a screw extruder according to the present invention,

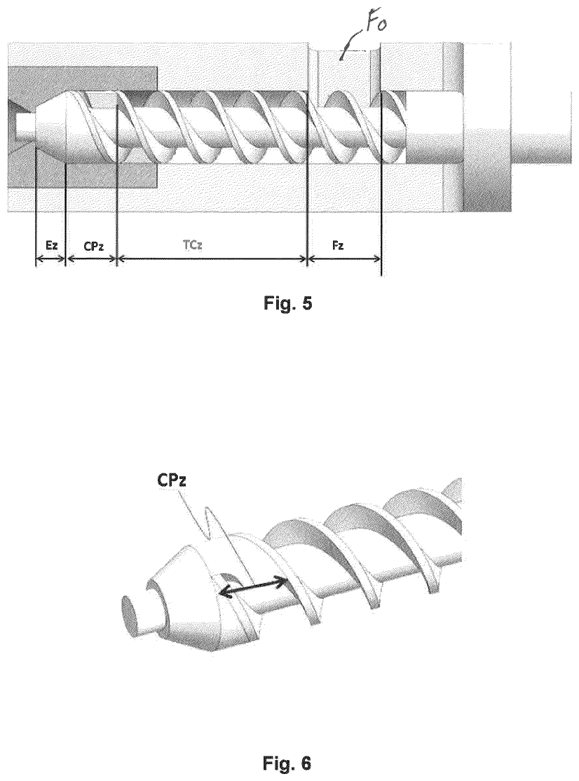

FIG. 6 discloses details of a compression head of an extruder,

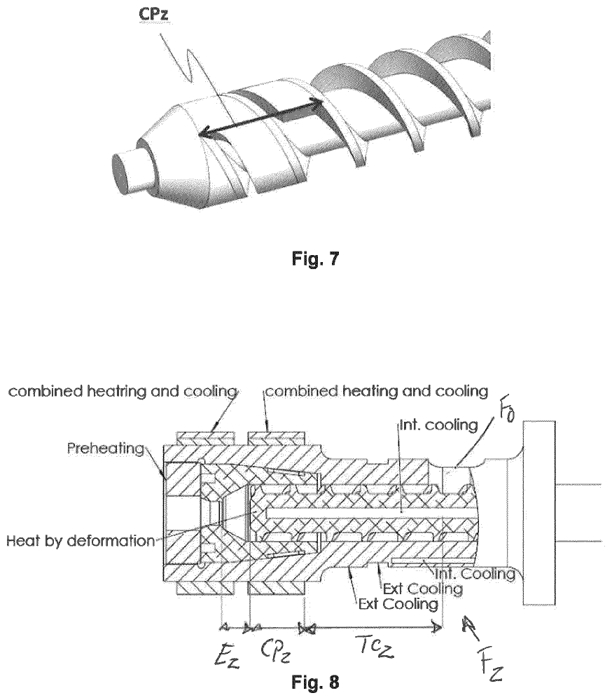

FIG. 7 discloses details of a compression head of an extruder,

FIG. 8 discloses details related to thermal control of an extruder,

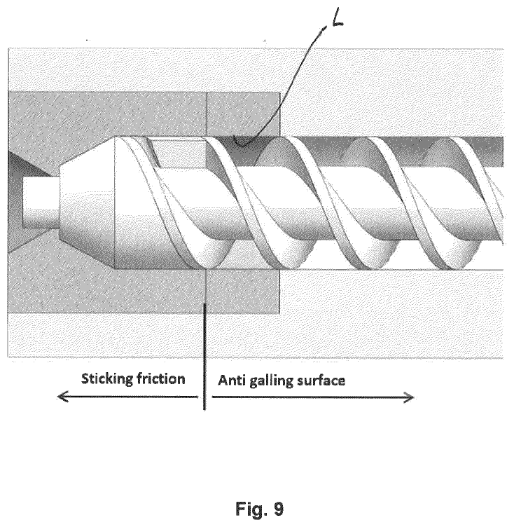

FIG. 9 discloses details of a liner construction that promotes Sticking Friction in a wanted area and provided with anti-galling surface in another area,

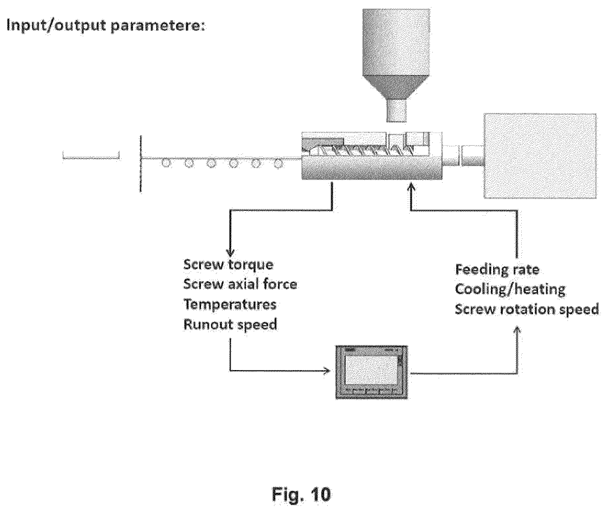

FIG. 10 discloses schematically principles for controlling a screw extruder apparatus and relevant control parameters.

As shown in FIG. 1, a screw extruder according to the invention can be included in an apparatus that comprises the following main process zones:
a preparation/mixing zone of material PMz
a feeding zone Fz
a transport and conditioning zone, TCz
a compacting and pressure generating zone, CPz
an extrusion zone Ez,
cut/packing analyzing zone CPAz
an extruded product 7

Before being fed into the screw extruder, the material is prepared and mixed in a preparation/mixing zone, PMz.

The screw extruder principally receives its material in feeding zone Fz provided with a feed opening Fo for the extruder, transport it and conditioning it in a transport and conditioning zone, TCz and exposes the material to compaction and pressure in zone, CPz.

The material is extruded in an extrusion zone Ez, and finally cut and packed in a cutting, packing and analysis zone CPAz.

A motor M is provided for generating rotation and torque of the screw of the screw extruder apparatus.

The screw can be single or multi flight, with fixed or without progressive pitch. A screw with multiple flights will improve material flow conditions, while a single flight screw will improve capacity. A progressive flight will enable a larger feeding volume, while a constant pitch result in easier control of the axial temperature gradient.

Preferably, the screw is prepared with a polished, hardened working surface and a core with more elastic properties.

Still further, as previously mentioned the input material can be of many different types and fractions. The feed of the material can preferably be a forced feed that is metered.

Still further, the input material can be pre-handled or prepared in several manners with regard to sorting, sizing (calibration), composition, cleaning, heating and more in one or more preparing and mixing steps, PMz. It should be understood that relevant steps can be done in vicinity of the apparatus or be performed at one other location depending on the design and layout of the plant.

The input material can be analyzed and classified according to pre-defined criterions before it is introduced in the apparatus. Based on this an appropriate adjustment of the apparatus's process parameters is enabled. For instance, the stick-slip criterion of an input material can be investigated upfront operating the apparatus.

There are several sources of general information that can be applied in this context. For instance the following paper:

“Key Engineering Materials, Vol. 491; Conditions for Sticking Friction between Aluminium Alloy AA6060 and Tool Steel in Hot Forming; F. Widerøe, Torgeir Welo”

URL: https://doi.org/10.4028/www.scientific.net/KEM.491.121″

Here it is described a method for determining conditions of sticking friction of an AI 6060 material. In the abstract is described that;

“The frictional conditions between an aluminium AA6060 alloy and tool steel in hot bulk forming have been investigated. The compressive-rotational method for frictional measurements, presented herein, represents an innovative approach for defining the thermo-mechanical conditions required for sticking friction at the interface between the two metals. Aluminium disks with inserted contrast material were subjected to a variety of pressures and rotated at one end at temperatures ranging from 250° C. to 500° C. Visual inspection of the surfaces in combination with sectioning of the deformed disks formed a method for studying how different factors affect a stick-slip criterion in metal forming. It was found that the normal contact pressure required for sticking to occur was strongly dependent on the instantaneous temperature. When comparing the normal contact pressure q with the characteristic shear strength k of the aluminium alloy, q/k>0.6 yielded sticking friction for temperatures above 300° C., while a ratio of 0.7 was required for the lower temperatures.”

These principles can be benefited from in classifying other materials and composites related to the invention.

As shown in FIG. 2 the apparatus can in general be controlled by a computer C that monitors the process on a monitor or screen Sc via information collected by sensors for torque, temperature, axial force measured in the rotating screw, among other process related parameters.

The process of operating the screw extruder shall be explained further by reference to FIGS. 3, 4 and 5.

The extruder is preferably fed through feed opening Fo with granular metal at T<Ts, where Ts is the temperature where the metal will have sticking friction in the apparatus.

To ensure that the metal will maintain this temperature, active cooling is employed to an extended zone from the feeding opening Fo. This ensures that it is freely moved via TCz towards an active zone CPz (FIG. 5). The active zone is covered by a liner. When the material is inside this liner it is in the CPz, and temperature is allowed to increase so sticking friction occurs. This temperature increase is mainly from frictional and deformation heat generated where the material is fully consolidated, around the screw tip.

In front of the screw in the zone E_{z}, a “billet” is continuously fed with material entering from the screw channels (FIG. 5). As the temperature is maintained above Ts in CPz and Ez, preferably at a length corresponding to approximately ½ a rotation of the screw (FIG. 6), a significant pressure drives extrusion in front of this “billet”. As this length of the screw tip then is covered by massive metallic material, heat generation (from friction and deformation) can be regulated by the rotation speed and/or torque of the screw and cooling in the same region.

Thus, one can maintain a temperature well above Ts, for instance approximately 0.9 Tm (Tm=melting temperature) to ensure stable extrusion conditions. At the same time, the temperature outside the processing area is kept well below Ts by active cooling. Maintaining this gradient is key; further by manipulating this gradient (by the above-mentioned parameters) one can adjust the degree of mixing/deformation (FIG. 7). A steep gradient can be considered when that approximately ½ a rotation of the screw is used to span the range from 0.9 Tm to below Ts. This will drive capacity and limit the degree of solid mixing to that region.

FIG. 6 and FIG. 7 show two cases, where the first have a higher capacity/throughput speed and the latter a higher degree of mixing.

Followingly, as the screw speed increases the heat generation is increased. Thus, maintaining the gradient (or low temperature at a section from the desired axial position) requires active cooling.

In this example, temperature control features are included in both screw and container, see FIG. 3.
Screw:
Feed opening; Fo
Internal cooling; 1
Container:
Internal cooling; 2,
External cooling; 3,
External heating; 4.

Alternatively, a response similar to active cooling can be achieved by increasing feed rate. This will affect the heat balance; if the feed rate is increased within the capacity of the screw, the same length will be an “active” (heat generating) volume. As more cold material enters the back of the screw and leaves as hot material through the die, the energy (heat) leaving the system will increase.

Q_(deformation heat)=Q_(active cooling)+Q_(out with the material)−balancing active cooling and energy out with the material to the heat from the deformation of the processed material will give a stable process. Further, it is not insignificant where the active cooling is employed, to maintain a correct temperature gradient. Cooling too much in CPz and Ez is not beneficial as there the temperature should be well above Ts, as stated on the previous page.

Correct parameters are known for several materials, but optimum process windows are being developed for a range of tool geometries and processing materials. E.g., tool geometry (reduction ratio) affects the pressure needed to be generated by the screw, different material (and combinations) will have different Ts and flow stress, etc.

To maintain correct parameters for a given tool geometry and material, a system is used to monitor and control the various parameters. A typical extruder setup consists of the following main elements, see FIG. 4:
Fo—Feed opening
11. Container
12. Screw
13. Driveline
14. Dosing unit
15. Runout table
16. Saw
17. Control unit

The control unit regulates the feed rate by adjusting the rotation speed of an external feed screw, tuning the feed rate to measurements of weights in the feeding hopper. See above example.

The driveline monitors torque and set rpm. According to one aspect of the invention, torque is used as an indirect measure of the relation between the feed rate and a runout speed measured at the runout table. The runout speed should match the feed rate in steady state. unless the torque (and heat generation) increases and followingly a rise in temperature in the zones CPz or TC_{z} happens. Thus, the extension of CPz can grow on the expense of the extension of TC_{z}.

Once reaching steady state, the process is observed with only minor fluctuations within small time span, for example in the temperature measured along the container. To ensure a stable steady-state process, the control unit uses one or more measurements of parameters as feed rate, runout speed, torque and temperatures to maintain a correct axial temperature gradient (and thus the length of the “active zone”; mainly CPz).

In a worst case where a wrong response in the control is triggered, this will result in a snowballing effect where the heat generation lead to more compacted material in the screw channel. This again will generate more heat to a point where it exceeds the active cooling. However, in one embodiment of the invention, by monitoring the torque (and runout speed), this can be avoided by a slight reduction in feed rate. The computer can be programmed to handle this situation.

Further, according to one aspect of the invention, monitoring the torque at steady state will provide further process information. At a point where melting of the material is about to occur due to a too high temperature, the torque will drop significantly.

A similar situation regarding the torque is likely to occur if the sticking friction in the operation is lost partly or wholly due to a too low temperature. The torque is monitored constantly by a sensor and a signal is led to the controller. The controller compares this information with the temperature measured by one or more sensors in the compacting zone and if the temperature is higher or lower than a set value a signal is produced, and the controller adjust the cooling or heating rate to bring the process into its range again.

In short, the extruder control system can according to aspects of the invention typically be based on input parameters from different elements:
Driveline:
   Screw torque and/or speed
   Screw axial load
Container:
   Temperature distribution
Dosing unit:
   Material feed rate
Runout table:
   Extrusion Speed

According to aspects of the invention and based on the input parameters, the extrusion process can be controlled through the following parameters:
Driveline:
   Screw rotational speed and/or torque
Screw/container:
   Heating/cooling rates
Runout table
   Cooling rate
Saw
   Cut length

According to aspects of the invention, active cooling in the transport zone should be maintained at a high level. Active cooling in the processing region should be tuned to a minimum, just enough so that the desired temperature as described above is maintained.

### Pre-Treatment, Feeding and Mixing of Material

The extruder uses a feeding system that can feed several materials mixed directly to the transport and conditioning zone TC_{z} in the screw extruder, through the feeding opening Fo. According to aspects of the invention, this feeding system may apply the state of the art technology of feeders, for instance screw-feeders, and load cells to get the correct feed rate and mixing ratios.

As the material enters the transport and conditioning zone, it needs to be evenly merged onto the compacted material further forwards (in the extrusion direction) in the screw channel.

According to aspects of the invention, pre-treatment of the input material is beneficial to achieve a stable steady-state process.

For instance, and if needed a degreasing step may reduce gas evolution during heating of the input material towards the “active zone” and thus minimize fluctuations of the length where one has sticking friction. This is due to that gas evolution may result in lift-off between either the process material and the internal surfaces or between input material compacted matters themselves.

However, it has been experienced that the apparatus can be fed with material with a high degree of pollution.

Further, by pre-treatment the increase in the bulk density of the input material has been observed to aid an increased capacity of the system. An input material with a high bulk density is deemed to need shorter axial length to be compacted into the “active zone”. I.e., it is assumed that LPC∝Δρ, where LPC is the axial length where pre-compaction towards the active zone happens and Δρ is the change in bulk density from input state to a fully dense billet in front of the screw.

### Controlling and Utilizing Surface Friction Conditions (manipulating Ts)

To ensure friction between the processed material and surrounding surfaces (including screw, tool, liner and prechamber region) it could be beneficial according to aspects of the invention to manipulate the friction of surrounding surfaces by coating, roughness or temperature to enable an optimum design.

In FIG. 5 it is disclosed a screw-extruder with the following zones (from the right to the left);
Fz, TCz, CPz, Ez

FIG. 6 shows a preferred shape of the compressed material in the CPz of a screw extruder.

FIG. 7 shows a situation where a large fraction of compacted material is occurring at the end of the screw and creates large torque and axial loads in the apparatus,

FIG. 8 discloses a schematic drawing indicating control of heat and cooling of an extruder with its screw. Length of CPz is deemed critical. Length of CPz correlated to—and can be monitored by the measurements of torque and temperature along axial positions. In other words, length of CPz can be controlled by cooling/heating and the ratio feeding/rotation speed. If CPz increases then more deformation heat is generated. Thus, the torque can be used as a parameter to set/adjust/tune the power of the cooling and heating or feeding rate and/or rotation speed during steady state.

FIG. 9 discloses details of a liner construction that promotes sticking friction in a desired area. In this area sticking friction will occur and thus this is typically the CPz part of the apparatus. The liner L is further provided with an anti-galling surface in another area, where sticking friction is not likely to occur. This latter area will typically be the TCz part of the apparatus.

Further, FIG. 10 discloses in more detail how the process carried out in the screw extruder can be further monitored and controlled. For instance, the water cooling can be increased to avoid heat transfer backwards in the apparatus. In addition, thermal breaks can be implemented for instance in the liner to facilitate increased temperature in front of the apparatus and avoiding increased temperature backwards.

It is also possible to coat selected parts of the liner to reduce heat generation and reduce the risk of sticking friction.

1. An apparatus for continuous extrusion of materials with high viscosity, in particular materials containing metals such as aluminium, magnesium, titanium, copper, nickel, zink and alloys thereof, the apparatus includes an Archimedes screw (12) rotationally provided within a liner (L) of a screw housing or container (11) provided with an inlet (Fo) for the feeding of the materials to be extruded, an extrusion zone (Ez) with an extrusion die assembly which forms the shape of the desired extruded product (7), the apparatus comprising a feeding zone Fz for material, a transport and condition zone TCz for the materials, and a compacting and pressure generating zone CPz for the materials, and where the compacted material formed in the compaction and pressure generation zone PCz and the compact plug of materials in the extrusion zone Ez is restricted from rigid rotation thus obtaining the required compaction and extrusion pressure,
wherein the apparatus is provided with means for controlling and adjusting the temperature of the material within a set range temperature before it is extruded to said product (7) and that the compaction pressure in the extrusion chamber is controlled within a set range pressure.

2. The apparatus according to claim 1,
wherein the rotation of the Archimedes screw is provided by a motor (M) with torque and or speed control, and that the torque and or speed is monitored and applied for adjusting the compaction pressure in the extrusion chamber based upon an algorithm that calculates torque and/or speed based upon registered pressure in the extrusion chamber.

3. The apparatus according to claim 1,
wherein the apparatus further comprises an upstream preparation/mixing zone PMz for treatment of the material.

4. The apparatus according to claim 1,
wherein the feeding zone Fz comprises means for controlling the temperature of the feed material to a certain predefined temperature.

5. The apparatus according to claim 1,
wherein the transport and conditioning zone TCz comprises means for controlling the temperature of the material to a certain predefined temperature.

6. The apparatus according to claim 1,
wherein the Archimedes screw is a double flight screw.

7. A method for continuous extrusion of materials with high viscosity, in particular metals such as aluminium, magnesium, titanium, copper, nickel, zink and alloys thereof, the method is performed in an apparatus including an Archimedes screw (12) rotationally provided within a liner (L) of a screw housing or container (11) provided with a feed opening (Fo) for the feeding of the material to be extruded, an extrusion sone (Ez) and an extrusion die assembly which forms the shape of the desired extruded product (7), the method further comprising
preparing a feeding material and feeding same from a feeding zone Fz through said feed opening Fo and further to a transport and conditioning zone TCz for pre-compacting said material and transporting it to a compacting and pressure generating zone CPz that forms part of an extrusion zone Ez, thus obtaining the pre-defined compaction and extrusion pressure,
wherein the temperature of the material in the extrusion zone Ez is controlled and adjusted to a set range temperature before it is extruded to form said product (7) and that the compaction pressure in the extrusion chamber is controlled within a set range pressure.

8. The method according to claim 7,
wherein the pressure of the material in the extrusion zone Ez is controlled and adjusted to a set pressure range before it is extruded for form said product (7).

9. The method according to claim 8,
wherein the rotation of the Archimedes screw is provided by a motor with torque and/or speed control, where the torque and/or speed is monitored and controlled for adjusting the compaction pressure in the extrusion chamber.

10. The method according to claim 7,
wherein the feeding zone Fz comprises means for controlling the temperature of the feed material to a certain predefined temperature.

11. The method according to claim 7,
wherein the transport zone Tz comprises means for controlling the temperature of the material to a certain predefined temperature.

12. The method according to claim 7,
wherein an upfront analysis and classification of the material is performed for tuning one or more process parameters of the apparatus before processing said material.
